(19) United States
(12) Patent Application Publication
(10) Pub. No.: US 2009/0115303 A1
(43) Pub. Date: May 7, 2009

(54) Electric lamp having an outer bulb

(76) Inventors: Thomas Bittmann, Friedberg (DE); Jurgen Graf, Augsburg (DE)

Correspondence Address: OSRAM SYLVANIA INC, 100 ENDICOTT STREET, DANVERS, MA, 01923, US

(21) Appl. No.: 11/989,593

(22) PCT Filed: Jul. 27, 2006
(86) PCT No.: PCT/EP2006/007470

§ 371 Date: Jan. 29, 2008

(30) Foreign Application Priority Data
Jul. 29, 2005 (DE) 10 2005 035 779.2

(51) Int. Cl. H01J 61/34; H01K 1/58; H01J 9/00

(52) U.S. Cl. 313/25; 313/567; 445/26

(57) ABSTRACT

A lamp elongated bulb (1) which defines a longitudinal axis (A), is closed on the opposite ends thereof by sealing parts (6; 32), to which an outer bulb is fixed via bulges. A neck adjacent to the outer bulb is produced by a specific method.

### TECHNICAL FIELD

The invention relates to an electric lamp having an outer bulb in accordance with the precharacterizing clause of claim 1. Suitable lamps are, in particular, metal halide lamps, mercury high-pressure discharge lamps or else halogen incandescent lamps having an outer bulb. The inner bulb of the lamp is sealed at two ends by sealing parts.

### PRIOR ART

EP 1 492 146 has disclosed a lamp having an outer bulb, which does not completely surround the inner bulb. The outer bulb is fixed to one or both sealing parts in each case by a neck part at the end.

DE 10 2004 056 452.3 (not yet laid open) has disclosed providing such an outer bulb in each case with a narrow neck part at the end which is fixed to a bead at the end of the seal of the inner bulb.

One disadvantage of these connection techniques is the fact that the foil in the sealing part of the inner bulb is subjected to a very severe thermal load, which may lead to premature failure of the lamp.

### SUMMARY OF THE INVENTION

The object of the present invention is to provide a lamp in accordance with the precharacterizing clause of claim 1, which keeps the thermal load on the current-supplying metallic components, which are in contact with the oxygen-containing atmosphere, as low as possible.

This object is achieved by the characterizing features of claim 1. Particularly advantageous refinements are described in the dependent claims.

The lamp according to the invention has an inner bulb, in particular a discharge vessel, which is sealed in a vacuum-tight manner, defines a lamp axis and is sealed at mutually opposite ends by sealing parts. The sealing part is a pinch seal or else a fuse seal. The luminous means in the interior of the lamp is a discharge arc between two electrodes or a luminous element. The luminous means is electrically conductively connected to the inner power supply lines leading to it. The sealing part is in particular provided with an outwardly protruding extension, which is in the form of a hollow tube.

Metallic current leadthrough components in the case of quartz glass lamps, in particular the power supply line and the foil, are subjected to a thermal load during lamp operation which may lead to premature lamp failures if it is too high and if the surrounding atmosphere contains oxygen. The failure mechanism is an instance of the power supply line burning through owing to oxidation or an instance of damage to the glass owing to oxidation of the metal parts, which damage may result in the arcing area opening. In the case of generic lamps, it has been established that typical service life values of 10,000 h or more are only achieved when oxidation processes which are too severe are largely avoided in the region of the power supply wires and fuse-seal foils. In this case, a measure of sufficiently safe lamp design is the temperature of the molybdenum foils at the outer ends of its vacuum-tight embedding in the quartz glass. At this point, the thermal load should always be below approximately 350° C. Known measures for achieving this are, for example, sufficiently long foil pinch seals or a severely enlarged surface area of the sealing parts consisting of glass. An increase in the mentioned limit value by 20 up to 40° C. can be achieved by an additional oxidation protection of the metallic components by means of coatings with, for example, chromium or platinum.

The described problem of temperature-dependent oxidation of the power supply components does not occur in the case of lamps having evacuated outer bulbs which are sealed off by means of a pinch seal, since, as a result, atmospheric oxygen is prevented from entering at the hot points of the current leadthrough by a system with a double seal via two molybdenum foils arranged one behind the other.

The invention describes a particular geometric shape for a gas-filled protective bulb by means of a tapering of its usually tubular diameter at the ends so far over its length that the convection of hot outer bulb filling gas is thus markedly impeded over the length of the lateral sealing parts of the lamp. Owing to the tapering of the ends of the outer bulb according to the invention, the temperature gradient is greater from the inside to the outside, with the result that the ends also become colder. This effect is also transferred to the metallic current leadthrough components of the lateral sealing parts of the lamp. Temperature can thus be emitted to the colder outer bulb filling gas and also outer bulb glass more effectively and more rapidly via the glass surfaces of the sealing parts. The temperature thus drops over the length of the sealing parts more rapidly from the inside towards the outside. As a result, lower temperatures at the end of the foil or shorter foil fuse seals or pinch seals are possible.

What is specifically involved here is an inner bulb which contains a luminous means (2) and is sealed at mutually opposite ends by sealing parts (6; 15) which contain foils (7), the outer bulb (14) having two narrowed neck parts (13) at its ends and being pulled over the inner bulb, and at least one neck part (13) being fixed to a connecting section (12) at the end of the sealing part of the inner bulb, characterized in that there is an end section (Z) of the sealing part, in which the distance (D) between the neck part and the sealing part is at most 4 mm, preferably at most 2.5 mm, this distance (D) towards the inner bulb being maintained at least to such an extent that the narrowed region of the neck part surrounds a subregion (Y) of the foil, which includes at least 20%, in particular at least 40%, of the axial length of the foil. The sealing parts are either fuse seals or pinch seals, which are H-shaped; the longest dimensions are preferably approximately square, in particular accurate to 30%.

The connecting section is preferably formed by an annular bead on the sealing part.

In order to suppress convection as effectively as possible, the distance between the neck parts and the seal should be as small as possible, but should be at least 0.1 mm, in particular at least 0.7 mm.

An improved cooling action is further achieved by the outer bulb being filled with a gas imparting a cooling effect, in particular being filled by more than 50% with an inert gas such as argon.

Sufficient cooling is already achieved if the axial length of the narrowed region is at least 4 mm, in particular at least 6 mm.

Depending on the production process, it may be expedient to ensure that the outer bulb with the two narrowed neck parts closes a hole located on the sealing part.

Depending on the lamp type and wattage, it may be helpful if the diameter of the neck part in the narrowed region is either constant or decreases in size towards the outside.

The total length of the narrowed neck part should normally be at most 20 mm, preferably at most 12 mm. In this case, the narrowing of a tubular glass body as a precursor to the outer bulb can be produced merely by means of roll-shaping or blowmolding processes after prior heating. The shorter the neck part the more easily this production process can be applied. This applies in particular to lengths up to 6 or up to 10 mm.

If the total length of the narrowed neck part is at least 6 mm, preferably at least 11 mm, the narrowing of the tubular glass body as a precursor to the outer bulb is produced by roll-shaping or blowmolding processes after prior heating, combined with hot shaping by means of drawing-out processes of the already narrowed parts of the outer bulb.

The production of such tapered regions makes particular savings on materials. The tapering of the ends of the outer bulb should in this case, including the radii or slopes which connect the maximum and minimum radial expansions of the outer bulbs to one another, tightly surround the region with the vacuum-tight sealing parts of the lamp, at least over a length of 2 mm and, at a maximum, over the entire length. The minimum inner diameter of the usually tubular outer bulb should in this case not be more than 4 mm away from the maximum outer diameter of the lateral sealing parts of the lamp in its tapered regions. The minimum inner diameter of the outer bulb can also correspond to the maximum outer diameter of the sealing parts, and they may even be partially connected to one another.

The outer bulb geometry advantageously has a similar geometry to the inner vessel, which means in principle that the distance between the outer bulb and the extension parts of the discharge vessel, i.e. the regions with the vacuum-tight current leadthrough components, should be at most 4 mm.

One particular problem in this case is the cost-effective production of such an outer bulb shape. In this case, there are essentially two possibilities. Firstly, the production from a plurality of individual parts usually having different dimensions, which are fixedly connected to one another by glass-melting processes. Secondly, such an outer bulb can also be brought to the desired shape from a blank by means of glass-shaping processes, which describes a particularly cost-effective embodiment.

This technique is suitable, for example, for a metal halide lamp having a relatively low power rating of 35 to 250 W.

The tapering of the outer bulb over a long length can in this case preferably be carried out in combination with a bead/bulge attachment technique on the sealing part, in particular the extension part of a seal of the inner vessel. This technique of creating a bead is known per se, for example from EP-A 588 602 or EP-A 465 083 and DE 10 2004 056 452.3.

It is likewise possible to combine the tapering with the exhaust hole sealing technique by means of a hole in the burner tube and subsequent sealing using the outer bulb glass. It is specifically this that results in a further advantage since glass mass can be reduced in the prerolled region by means of additional drawing-out, which has proven to be a particularly advantageous embodiment, and this makes it easier to seal the exhaust hole lying therebeneath.

The production of the tapered ends of the outer bulb by means of glass shaping over a relatively long length is demanding. “Normal” tapering over a length of a maximum of 55% of the diameter of the outer bulb can be produced relatively easily by means of a multi-stage roll-shaping process in the case of rotating glass. A typical example is a length of the tapered part, which is defined here as the neck length, of from 2 to 12 mm, given a typical diameter of approximately 22 mm for the outer bulb.

The production of a longer neck part is possible, as is known, with a very high degree of difficulty using a multi-stage free rolling process and is no longer technically sensible above lengths of at least 75% of the diameter of the outer bulb, for example of approximately 17 mm given a diameter of 22 mm. An alternative is a technique in which a plurality of glass tubes having different diameters are placed one behind the other. However, one disadvantage of this is the increased complexity in terms of manufacture and increased cost, owing to additional lamp components.

Production using a combined rolling and drawing process is more simple and more cost-effective. In this case, first the maximum possible length HTL of the neck part, i.e. approximately 50% of the outer diameter of the outer bulb, is manufactured using the known free rolling process. The actual final length of the neck part is achieved in a further step by means of drawing-out in the region of the already rolled section. This also has the advantage that any material accumulations in the prerolled region can be drawn out again to uniform wall thicknesses.

The outer bulb is advantageously a bulb having a central bulge and tube pieces adjoining at the ends, which are in particular attached or integrally formed, said tube pieces in this case being referred to as neck parts.

One preferred embodiment envisages a tubular extension piece of the sealing part in the case of an inner vessel, a bead adjoining said tubular extension piece. In particular, the tubular extension piece is attached or integrally formed. As a result, even in the case of a pinch seal which is not radially symmetrical, it is possible to provide a radially symmetrical bead. The bead may be produced from the sealing part, for example by means of compression, or placed thereon in the form of a separate pearl. The ability of the connection between the outer bulb and the bead to withstand breakage increases the more intimate the contact is between the two.

Both the inner bulb and the outer bulb preferably consist of quartz glass or hard glass.

One possible specific production process is based on the following steps:

a.) providing a fitted inner vessel consisting of glass, in particular a tube consisting of quartz glass, which defines an inner volume and has two ends, in each case one current leadthrough system protruding from the outside into the volume via the ends, the system in particular being an electrode system which comprises at least one electrode, a foil and a power supply line, the inner volume being filled with a gas-containing filling, the end of the inner vessel being formed by means of a sealing part, which surrounds a central part of the current leadthrough system in a gas-tight manner, and possibly an extension part, which contains an outer part of the current leadthrough system;

b.) providing a second tube consisting of quartz glass having a given maximum outer diameter with a greater dimension and two open ends, the dimension of the second tube being such that the second tube covers the inner volume and at least the sealing region and possibly a certain part of the extension part;

c.) pulling the second tube over the inner vessel;

d.) shaping a narrowed neck part at a first end of the second tube over a length of typically 4 to 10 mm by means of a roll-shaping process; for this purpose, the region to be shaped on the glass part is heated and is pushed so far inwards by a rotating shaping roller that a neck part having a smaller diameter results; for typical lengths of greater than 10 mm of the neck part, the described roll-shaping is also combined with a drawing-out process on the already preshaped glass part by means of heating and subsequent axial drawing, with the result that the neck part is also extended;

e.) shaping of a second narrowed neck part at the second end in a similar manner to step d.);

f.) connecting the outermost end of the shaped neck part of the first side to the extension part of the inner vessel;

g.) connecting the shaped neck part of the second side to the extension part of the inner vessel.

### BRIEF DESCRIPTION OF THE DRAWINGS

The invention will be explained in more detail below with reference to a plurality of exemplary embodiments. In the drawings:

FIG. 1 shows a side view (FIG. 1a) and a cross section (FIG. 1b) of a halogen incandescent lamp;

FIG. 2 shows a side view (FIG. 2a) and a cross section (FIG. 2b) of an exemplary embodiment of a metal halide lamp; and FIGS. 3 to 5 show the method steps for producing a metal halide lamp as shown in FIG. 2.

### PREFERRED EMBODIMENT OF THE INVENTION

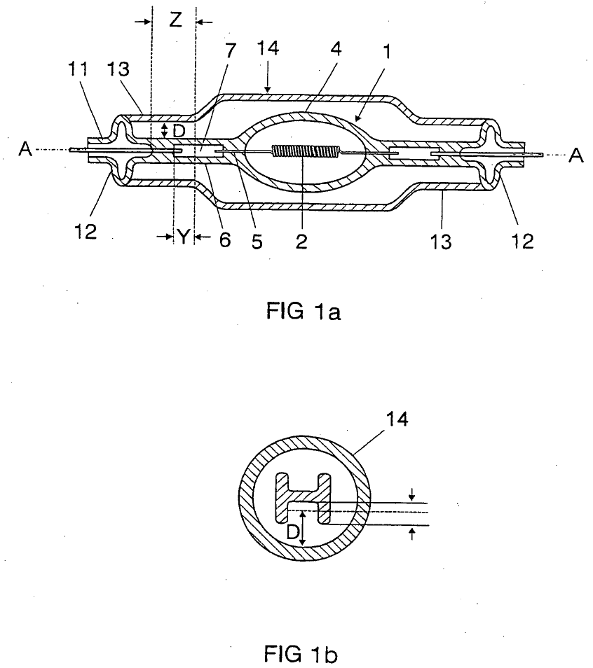

FIG. 1a shows the side view of a halogen incandescent lamp with a pinch seal at two ends. It comprises an inner bulb 1, a luminous element 2 being arranged axially in the central part 4 of said inner bulb 1.

The ends 5 of the luminous element, in terms of their function as an inner power supply line, are embedded directly in the pinch seal 6 and are connected to a pinch foil 7 there.

On the outside, the pinch seal 6 has a tubular glass sleeve 11, which is integrally formed on the pinch seal, as the extension part which may also be used as part of the base.

A bead 12 is formed on the sleeve 11 towards the outside transversely with respect to the lamp axis. That end of an outer bulb 14 which is in the form of a narrowed cylindrical neck part 13 is placed on said bead 12 such that the outer bulb extends with two neck parts 13 between the two beads 12 on both sides of the central part 4.

In addition, a base may be fitted to one end of the sealing part, as is known per se, the base having an electrical contact element (not illustrated), which is electrically conductively connected to a power supply line leading to a luminous means, the contact element being accommodated in the tubular extension of the sealing part.

The distance D between the narrowed neck part and the H-shaped pinch seal 6 is 1.5 mm. In this case, the distance D is intended to mean the mean value between the trough of the pinch seal on the broad side and the two tips of the H, see FIG. 1b. An H-shaped pinch seal has a large surface area and therefore cools the seal very well.

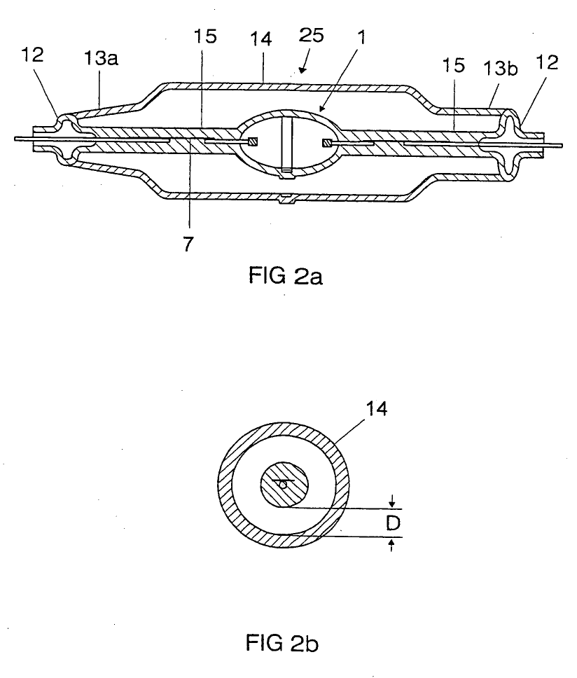

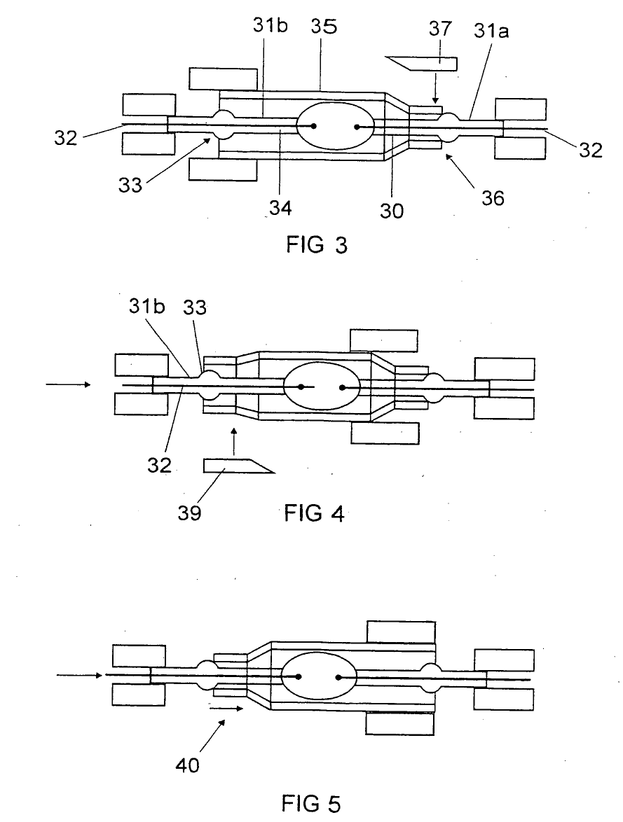

A metal halide lamp 25 is shown in FIG. 2a which is sealed off by fuse seals 15. In this case, one neck part 13a is designed to be narrowed towards the outside in order to improve the suppression of convection, whereas the other neck part 13b has a constant diameter, but is manufactured from a separate tube piece which is attached to the outer bulb on the slope pointing inwards. The coldfilling pressure in the outer bulb in the case of an argon filling is, in particular, from 200 to 400 mbar.

The production is carried out such that, initially, as a preparation step, the discharge vessel is shaped, fitted with a leadthrough system, filled with a gas filling and then sealed. These steps are known per se.

FIG. 3 shows a first step for the further production. In this case, a fitted inner vessel 13 consisting of glass is provided, in particular a tube consisting of quartz glass, which defines an inner volume and has two sealed-off ends 31, in each case one current leadthrough system 32 protruding from the outside into the volume via the ends. This system is in particular an electrode system which comprises at least one electrode, a foil and a power supply line. The inner volume of the discharge vessel is filled with a gas-containing filling, the end 31 of the inner vessel being formed by means of a sealing part 34, which surrounds a central part of the current leadthrough system in a gas-tight manner, and an extension part having a bead 33, which contains an outer part of the current leadthrough system.

In a second step, a second outer tube 35 consisting of quartz glass having a given maximum outer diameter with a greater dimension than the discharge vessel and having two open ends is provided, the dimension of the second tube 35 being such that the second tube covers the inner volume of the discharge vessel and at least the sealing region and possibly a certain part of the extension part.

In a third step, the second tube is pulled over the inner vessel.

In a fourth step, a first narrowed neck part 36 is shaped at a first end of the second tube 35 over a length of typically from 4 to 10 mm by means of a roll-shaping process. For this purpose, the region to be shaped on the glass part is heated and is pushed so far inwards by a rotating shaping roller 37 that the neck part 36 having a reduced diameter results.

In a fifth step, a second narrowed neck part is shaped at the second end 31b by means of a second shaping roller 39 in a similar manner to in the fourth step, see FIG. 4 in this regard.

In a sixth step, the outermost end of the shaped neck part on the first side 31a is connected to the extension part of the inner vessel (not illustrated).

In a seventh step, the shaped neck part on the second side 31b is connected to the extension part of the inner vessel (not illustrated).

For typical lengths L of the neck part of L greater than 10 mm, the described roll-shaping process is also combined with a drawing-out process on the already preshaped glass part by means of heating and subsequent axial drawing (arrow 40), with the result that the neck part 36 is also extended; see FIG. 5.

In the latter steps, it is possible in each case for rinsing to take place using argon and possibly even for a glove box to be used.

1. An electric lamp having an outer bulb (14) and having an elongate inner bulb (1), which is sealed in a vacuum-tight manner, defines a longitudinal axis (A), contains a luminous means (2) and is sealed at mutually opposite ends by sealing parts (6; 15) which contain foils (7), the outer bulb (14) having two narrowed neck parts (13) at its ends and being pulled over the inner bulb, and at least one neck part (13) being fixed to a connecting section (12) at the end of the sealing part of the inner bulb, characterized in that there is an end section (Z) of the sealing part, in which the distance (D) between the neck part and the sealing part is at most 4 mm, preferably at most 2.5 mm, this distance (D) towards the inner bulb being maintained at least to such an extent that the narrowed region of the neck part surrounds a subregion (Y) of the foil, which includes at least 20%, in particular at least 40%, of the axial length of the foil.

2. The electric lamp having an outer bulb as claimed in claim 1, characterized in that the connecting section is formed by an annular bead (12) on the sealing part.

3. The electric lamp having an outer bulb as claimed in claim 1, characterized in that the minimum gap of the neck part in the narrowed region is at least 0.1 mm, in particular at least 0.7 mm.

4. The electric lamp having an outer bulb as claimed in claim 1, characterized in that the outer bulb is filled with a gas imparting a cooling effect, in particular is filled by more than 50% with an inert gas such as argon.

5. The electric lamp having an outer bulb as claimed in claim 1, characterized in that the axial length of the narrowed region is at least 4 mm, in particular at least 6 mm.

6. The electric lamp having an outer bulb as claimed in claim 1, characterized in that the outer bulb with the two narrowed neck parts closes a hole located on the sealing part.

7. The electric lamp having an outer bulb as claimed in claim 1, characterized in that the diameter of the neck part in the narrowed region is either constant or decreases in size towards the outside.

8. The electric lamp having an outer bulb as claimed in claim 1, characterized in that the total length of the narrowed neck part is at most 20 mm, preferably at most 12 mm, the narrowing of a tubular glass body as a precursor to the outer bulb having been produced merely by means of roll-shaping or blowmolding processes after prior heating.

9. The electric lamp having an outer bulb as claimed in claim 1, characterized in that the total length of the narrowed neck part is at least 6 mm, preferably at least 11 mm, the narrowing of a tubular glass body as a precursor to the outer bulb having been produced by roll-shaping or blowmolding processes after prior heating, combined with hot shaping by means of drawing-out processes of the already narrowed parts of the outer bulb.

10. The electric lamp having an outer bulb as claimed in claim 1, characterized in that the outer bulb and the narrowed neck parts comprise a plurality of components having different dimensions.

11. A method for producing an electric lamp having an outer bulb (12) and having an elongate inner vessel arranged therein, in particular a discharge vessel (2), the following method steps being used:
a.) providing a fitted inner vessel consisting of glass, in particular a tube consisting of quartz glass, which defines an inner volume and has two ends, in each case one current leadthrough system protruding from the outside into the volume via the ends, the system in particular being an electrode system which comprises at least one electrode, a foil and a power supply line, the inner volume being filled with a gas-containing filling, the end of the inner vessel being formed by means of a sealing part, which surrounds a central part of the current leadthrough system in a gas-tight manner, and possibly an extension part, which contains an outer part of the current leadthrough system;
b.) providing a second tube consisting of quartz glass having a given maximum outer diameter with a greater dimension and two open ends, the dimension of the second tube being such that the second tube covers the inner volume and at least the sealing region and possibly a certain part of the extension part;
c.) pulling the second tube over the inner vessel;
d.) shaping a narrowed neck part at a first end of the second tube over a length of typically 4 to 10 mm by means of a roll-shaping process; for this purpose, the region to be shaped on the glass part is heated and is pushed so far inwards by a rotating shaping roller that a neck part having a smaller diameter results; for typical lengths of greater than 10 mm of the neck part, the described roll-shaping is also combined with a drawing-out process on the already preshaped glass part by means of heating and subsequent axial drawing, with the result that the neck part is also extended;
e.) shaping of a second narrowed neck part at the second end in a similar manner to step d.);
f.) connecting the outermost end of the shaped neck part of the first side to the extension part of the inner vessel;
g.) connecting the shaped neck part of the second side to the extension part of the inner vessel.
